(19) United States
(12) Patent Application Publication
(10) Pub. No.: US 2025/0119056 A1
(43) Pub. Date: Apr. 10, 2025

(54) POWER SUPPLY CONTROL CIRCUIT, RELATED POWER SUPPLY AND METHOD OF OPERATING A POWER SUPPLY

(71) Applicant: STMicroelectronics International N.V., Geneva (CH)

(72) Inventors: Fabio CACCIOTTO, Camporotondo Etneo (IT); Salvatore TORRISI, Aci Castello (IT)

(73) Assignee: STMicroelectronics International N.V., Geneva (CH)

(21) Appl. No.: 18/891,647

(22) Filed: Sep. 20, 2024

(30) Foreign Application Priority Data
Oct. 4, 2023 (IT) 102023000020469

(51) Int. Cl. H02M 1/42; H02J 7/02; H02M 1/00; H02M 3/335

(52) U.S. Cl. CPC H02M 1/4225; H02J 7/02; H02M 1/0016; H02M 3/33507; H02J 2207/20; H02J 2207/50

(57) ABSTRACT

Provided is a power supply control circuit for a power supply, including a PFC converter configured to generate a bus voltage, an electronic converter and an auxiliary power supply configured to generate an auxiliary supply voltage. The PFC converter comprises a PFC control circuit configured to drive the PFC converter to regulate the bus voltage to a requested value. When the output power is greater than the threshold, the power supply control circuit supplies the PFC control circuit with the auxiliary supply voltage. When the output power is smaller than the threshold, the circuit compares the bus voltage to upper and lower thresholds. When the bus voltage is greater than the upper threshold, the circuit inhibits supply of the PFC control circuit with the auxiliary supply voltage. When the bus voltage is smaller than a lower threshold, the circuit supplies the PFC control circuit with the auxiliary supply voltage.

### BACKGROUND

### Technical Field

Embodiments of the present description relate to a power supply control circuit for a two stage-stage power supply comprising a Power Factor Correction (PFC) electronic converter, such as a boost converter.

### Description of the Related Art

Switched-mode power supplies are well-known in the art. For example, FIG. 1 shows a typical two-stage electronic power supply.

In the example considered, the power supply comprises two input terminals 200a and 200b configured to receive an AC input voltage V_{in,AC}, such as 230 VAC with 50 Hz or 110 VAC with 60 Hz, and two output terminals 202a and 202b configured to provide a regulated output voltage Vₒᵤₜ or a regulated output current iₒᵤₜ to a load 30.

Specifically, in the example considered, the AC input voltage V_{in,AC} is converted via a rectifier circuit 206, such as a bridge rectifier, into a DC voltage, i.e., the input terminals of the rectifier circuit are coupled to the input terminals 200a and 200b, and output terminals 208a and 208b of the rectifier circuit provide a DC voltage V_{in,DC}. Often a filter circuit 204 is connected between the input terminals 200a and 200b and the input terminals of the rectifier circuit 206.

In the example considered, the power supply comprises two stages:
a first stage 210 configured to receive via the terminals 208a and 208b the DC voltage V_{in,DC} and generate at two terminals 212a and 212b a regulated DC voltage V_{bus}; and
a second stage 214 configured to receive via the terminals 212a and 212b the voltage V_{bus} and generate at the output terminals 202a and 202b a regulated output voltage Vₒᵤₜ or a regulated output current iₒᵤₜ.

Specifically, as described, e.g., in Unites States Patent Publication No. U.S. Pat. No. 6,222,746 B1 such a two-stage architecture has the advantage that the first stage 210 may be an electronic converter with Power Factor Correction (PFC), which thus generates a regulated voltage V_{bus}, while improving the power factor of the power supply. For example, often the first stage is implemented with a PFC boost converter. Conversely, based on the value of the voltage V_{bus} and the power supply requirements of the load 30, the second stage 214 may be implemented with various kinds of electronic converters, such as buck, buck-boost, flyback, forward, half-bridge or full-bridge converters.

For example, FIG. 2A shows an example of the PFC boost converter 210.

Specifically, in the example considered, the stage 210 comprises:
an inductance L1, such as an inductor, connected (e.g., directly) between the positive terminal 208a and a switching node SN;
an electronic switch SW1, such as a Field-Effect Transistor (FET), such as a Metal-Oxide-Semiconductor Field-Effect Transistors (MOSFET), e.g., a n-channel FET, e.g., a NMOS, having a current path connected (e.g., directly) between the switching node SN and the negative terminal 208b;
a further electronic switch SW2, such as a diode or a further FET, such as a p-channel FET, e.g., a PMOS, having a current path connected (e.g., directly) between the switching node SN and the positive terminal 212a, wherein the negative terminal 212b is connected to the negative terminal 208b; and
a capacitor COUT connected (e.g., directly) between the terminals 212a and 212b.

Optionally, the stage 210 may also comprise a capacitor CIN connected (e.g., directly) between the terminals 208a and 208b. In general, the respective capacitance between the terminals 208a and 208b should be small in order to not influence significantly the power factor of the power supply. In fact, in a PFC stage 210, the voltage V_{in,DC} at the terminals 208a and 208b corresponds essentially to positive sinusoidal half-waves.

In the example considered, the PFC stage 210 comprises also a PFC control circuit 2112 configured to generate a drive signal DRV1 for the electronic switch SW1 and optionally the electronic switch SW2 (if a controllable electronic switch is used).

As shown in FIG. 2B, the PFC control circuit 2112 is usually configured to drive the electronic switch SW1 with switching cycles T_{SW} comprising:
a switch-on phase T_{ON}, where the switch SW1 is closed and the diode/switch SW2 is opened, whereby the current flowing through the inductance L1 increases; and
a switch-off phase T_{OFF}, where the switch SW1 is opened and the diode/switch SW2 is closed, whereby the current of the inductance L1 passes through diode/switch SW2 towards output 212a/212b, thereby charging the capacitor COUT.

Therefore, the increase of the current flowing through the inductance L1 during the on-state depends on the duration of the switch-on duration T_{ON} and the input voltage V_{in,DC}. Specifically, assuming an ideal behavior of the boost converter, when the switch-on time T_{ON} remains constant, the peak value of the input current i_{in,DC} received via the terminals 208a and 208b at the end of the switch-on time T_{ON} is substantially proportional to the value of the voltage V_{in,DC}. Therefore, the boost converter is particularly suitable to be used within a PFC converter.

The various modes of operation of a PFC boost converter are well known in the art. For example, in this context may be cited STMicroelectronics, Application note AN2761, “Solution for designing a transition mode PFC preregulator with the L6562A”, November 2009, Doc ID 14690 Rev 2, or Sam Abdel-Rahman, Franz Stückler, Ken Siu, Application Note, “PFC boost converter design guide—1200 W design example”, Revision 1.1, 2016 Feb. 22.

Substantially, the PFC control circuit 2112 may be configured to operate the boost converter in three modes: continuous conduction mode (CCM), discontinuous conduction mode (DCM) or critical conduction mode (CrCM), often also identified as transition mode (TM).

As schematically shown in FIG. 2A, these control schemes have in common, that a voltage sensor 2110 is used to generate a feedback signal FB1 indicative of (and preferably proportional to) the voltage V_{bus} at the terminals 212a/212b. For example, in the example considered, the voltage sensor 2110 is implemented with a resistive voltage divider comprising two resistors R1 and R2 connected between the terminals 212a and 212b.

In the example considered, the feedback signal FB1 is fed to an error amplifier 2114 configured to generate an error signal V_{COMP1} as a function of the feedback signal FB1 and a reference signal REF1 indicative of a requested value for the voltage V_{bus}. Typically, the error amplifier 2114, such as an operation amplifier, has associated a feedback/compensation network 2118, which permits to implement the error amplifier 2114 as a regulator having an Integral (I) and/or Proportional (P) component, and optionally a Derivative (D) component. More specifically, the error amplifier 2114 usually provides a current signal which is converted by the feedback/compensation network 2118 into a voltage error signal V_{COMP1}.

A driver circuit 2116 is then configured to generate the drive signal(s) DRV1 (for the switch SW1 and optionally the switch SW2) as a function of the error signal V_{COMP1}. For example, as mentioned before, the driver circuit 2116 may vary the switch-on time T_{ON} as a function of the signal V_{COMP1}.

Often the feedback via the error amplifier 2114 represents an outer (slow) control loop, while the driver circuit 2116 may also implement an inner (fast) control loop, e.g., in order to directly regulate the current flowing through the inductance L1. For example, as schematically shown in FIG. 2A, for this purpose, the boost converter may also comprise a current sensor 2120, such as a resistor RS, configured to generate a signal CS indicative of (and preferably proportional to) the current flowing through the inductance L1, at least during one of the switch-on or the switch-off period.

Conversely, FIG. 3 shows a scheme of a generic regulated DC/DC converter 214.

Specifically, a generic switched-mode DC/DC converter comprises:
a switching stage 2140 comprising one or more electronic switches SW and one or more reactive components, such as inductances L and/or capacitances C;
a measurement circuit 2142 configured to generate a feedback signal FB2 indicative of (and preferably proportional to) the output current iₒᵤₜ or the output voltage Vₒᵤₜ (based on whether the converter provides a regulated current or a regulated voltage), such as a resistive voltage divider comprising two resistors R3 and R4 connected between the terminals 202a and 202b; and
a control circuit 2144 configured to generate one or more drive signals DRV2 for the one or more electronic switches SW.

For example, similar to what has been described with respect to FIG. 2A, also the control circuit 2144 may comprise:
an error amplifier 2146 having associated a feedback network 2150, wherein the error amplifier 2146 is configured to generate an error signal V_{COMP2} as a function of the feedback signal FB2 and a reference signal REF2 indicative of a requested value for the output current iₒᵤₜ or the output voltage Vₒᵤₜ; and
a driver circuit 2148 configured to generate the one or more drive signals DRV2 as a function of the error signal V_{COMP2}.

As described, e.g., in U.S. Pat. No. 11,258,354 B2, the above-described modes DCM, CCM and CrCM, are usually used, when a load 30 is connected to the terminals 202a and 202b. Conversely, when no load 30 is connected to the terminals 202a and 202b, or in general when the load between the terminals 202a and 202b is small, the regulation with the modes DCM, CCM and CrCM becomes usually inefficient, and the control circuit 2144 may switch to a Burst Mode (BM), wherein the control circuit 2144 activates the switching of the electronic switch(es) SW for one or more switching cycles and then deactivates the switching. Similarly, also the control circuit 2112 of the converter 210 may be configured to selectively switch to a burst mode at low load conditions.

For example, the control circuit 2112 (or similarly the control circuit 2144) may activate the burst mode directly as a function of the feedback signal FB1 (FB2) or as a function of the error signal V_{COMP1} (V_{COMP2}).

For example, at low/light load conditions, the respective output voltage V_{bus} (Vₒᵤₜ) may increase and the control circuit 2112 (2144) may be configured to activate the burst mode, e.g., by simply stopping the switching activity, when the voltage V_{bus} (Vₒᵤₜ) exceeds an upper threshold and the normal operation mode (DCM, CCM or CrCM), e.g., by resuming the switching activity, when the voltage V_{bus} (Vₒᵤₜ) falls below a lower threshold.

Instead, when using an error amplifier 2114 (2146) with an integral component in the feedback network 2118 (2150), such as a capacitor, the respective error signal V_{COMP1} (V_{COMP2}) will decrease when the load decreases. Substantially, when using an output voltage regulation for the voltage V_{bus} (Vₒᵤₜ) the error signal V_{COMP1} (V_{COMP2}) is (approximately) proportional to the current supplied by the converter 210 (214). Thus, in this case, the control circuit 2112 (2144) may be configured to activate the burst mode, e.g., by simply stopping the switching activity, when the error signal V_{COMP1} (V_{COMP2}) falls below a lower threshold and the normal operation mode (DCM, CCM or CrCM), e.g., by resuming the switching activity, when the error signal V_{COMP1} (V_{COMP2}) exceeds an upper threshold. For example, if the error signal V_{COMP1} (V_{COMP2}) is lower than the lower threshold, the control circuit 2112 (2144) inhibits the switching activity. In this way, the current supplied by the converter 210 (214) is stopped. In any case, e.g., due to power losses or because the load 30 still consumes energy, the voltage V_{bus} (Vₒᵤₜ) and similarly the feedback signal FB1 (FB2) decreases. This causes an increase of the error signal V_{COMP1} (V_{COMP2}). Accordingly, when the error signal V_{COMP1} (V_{COMP2}) exceeds the upper threshold, the control circuit 2112/2144 may restart the switching that transfers energy to the load.

As shown in FIG. 4, recently control circuits 2112 and 2144 have been proposed, which support a communication via a signal EXT_BM of the burst mode from the control circuit 2144 of the converter 214 to the control circuit 2112 of the PFC converter 210. For example, in this context may be cited the Datasheet of the integrated circuit STNRG011, “Digital combo multi-mode PFC and time-shift LLC resonant controller”, which is an integrated circuit comprises both a control circuit 2112 for a PFC converter 210 and a control circuit 2144 for an LLC electronic converter 214.

For example, the control circuit 2144 may be configured to set the signal EXT_BM to high, when the control circuit 2144 has activated the burst mode, e.g., because the signal FB2 exceeds an upper threshold or the error signal V_{COMP2} falls below a lower threshold. This signal EXT_BM is thus provided to the PFC control circuit 2112. For example, the PFC control circuit 2112 may deactivate the switching activity of the boost converter (in particular the electronic switch SW1) in response to the signal EXT_BM. This mechanism allows to synchronize the BM state of the first stage 210 with that of the second stage 214 improving the efficiency of the whole system consisting of both conversion stages. In this way the BM state is imposed for both stages by the second stage.

In general, the PFC control circuit 2112 may comprise both the External Burst Mode (EBM) function as well as the (internal) BM function, i.e., the PFC control circuit 2112 may stop the switching activity when at least one of the following conditions is satisfied:
when the signal EXT_BM is set to a given logic level; or
when the signal FB2 exceeds an upper threshold or preferably the error signal V_{COMP2} falls below a lower threshold.

### BRIEF SUMMARY

Considering the foregoing, various embodiments of the present disclosure provide solutions for improving the operation of a PFC stage 210.

According to one or more embodiments, one or more of the above objects are achieved by a power supply control circuit having the distinctive elements set forth specifically in the ensuing claims. Embodiments moreover concern a related power supply and method.

The claims form an integral part of the technical teaching of the description provided herein.

As mentioned before, various embodiments of the present disclosure relate to a power supply control circuit for a power supply. The power supply comprises two input terminals configured to be connected to the mains for receiving an AC input voltage and two output terminals configured to be connected to a load. The power supply comprises moreover a rectifier circuit, a PFC electronic converter and an electronic converter. Specifically, the rectifier circuit is configured to generate a rectified input voltage from the AC input voltage. The PFC electronic converter is configured to generate a bus voltage from the rectified input voltage. The electronic converter is configured to generate at the two output terminals a regulated output voltage or a regulated output current from the bus voltage. For example, the electronic converter may comprise a control circuit, wherein the control circuit and the power supply control circuit are integrated in the same integrated circuit.

Specifically, in various embodiments, the PFC electronic converter comprises a PFC control circuit comprising a terminal for received a supply voltage, wherein the PFC control circuit is configured, when supplied via the supply voltage, to drive the PFC electronic converter in order to regulate the bus voltage to a requested value. For example, in various embodiments, the PFC electronic converter is a boost converter comprising a positive and a negative input terminal for receiving the rectified input voltage, a positive and a negative output terminal for providing the bus voltage, an inductance connected between the positive input terminal and a switching node, an electronic switch connected between the switching node and the negative terminal, and a further diode or further electronic switch connected between the switching node and the positive output terminal. Moreover, the boost converter comprises a feedback circuit configured to generate a feedback signal proportional to the bus voltage, wherein the PFC control circuit is configured, when supplied via the supply voltage, to drive the electronic switch and optionally the further electronic switch in order to regulate the feedback signal to a reference value, which indicates the requested value of the bus voltage.

In various embodiments, the power supply comprises also an auxiliary power supply configured to generate an auxiliary supply voltage. For example, the auxiliary power supply may comprise a capacitor and a charge circuit configured to charge the capacitor via the rectified input voltage. In this respect, in various embodiments, the electronic converter is a flyback converter comprising a transformer having an auxiliary winding, wherein the auxiliary winding is connected via a diode to the capacitor.

Specifically, in various embodiments, the power supply control circuit is configured to generate a signal indicative of the output power provided via the two output terminals. For example, for this purpose, the power supply control circuit may estimate a signal proportional to the output voltage and a signal proportional to the output current, and generate the signal indicative of the output power by multiplying the signal proportional to the output voltage with the signal proportional to the output current. Alternatively, the power supply control circuit may estimate a signal proportional to the bus voltage and a signal proportional to the current provided to the electronic converter, and generate the signal indicative of the output power by multiplying the signal proportional to the output voltage with the signal proportional to the output current. Alternatively, the electronic converter may be configured to generate a regulated output voltage, and the signal indicative of the output power may be proportional to the output current provided via the two output terminals. Alternatively, the electronic converter may be configured to generate a regulated output current, and the signal indicative of the output power may be proportional to the output voltage at the two output terminals. For example, when the electronic converter is based on a flyback converter, the output voltage may be estimated by sampling the voltage at the auxiliary winding during a switch-off period of the flyback converter.

In various embodiments, the power supply control circuit is configured to determine whether the signal indicates that the output power is greater than a threshold value. In response to determining that the signal indicates that the output power is greater than a threshold value, the power supply control circuit supplies the PFC control circuit with the auxiliary supply voltage. For example, in various embodiments, the power supply control circuit comprises a terminal configured to be connected to a set resistor, wherein the threshold value is defined via the resistance value of the set resistor.

Conversely, in response to determining that the signal indicates that the output power is smaller than a threshold value, the power supply control circuit generates a signal indicative of the bus voltage. Specifically, in various embodiments, the power supply control circuit verifies whether the signal indicates that the bus voltage is greater than an upper threshold and, in response to determining that the signal indicates that the bus voltage is greater than the upper threshold, the power supply control circuit inhibits the supply of the PFC control circuit with the auxiliary supply voltage, whereby the PFC control circuit is switched off. Moreover, the power supply control circuit verifies whether the signal indicates that the bus voltage is smaller than a lower threshold and, in response to determining that the signal indicates that the bus voltage is smaller than the lower threshold, the power supply control circuit supplies the PFC control circuit with the auxiliary supply voltage. For example, in various embodiments, the lower threshold is selected in a range between 45% and 55% of the requested value, and the upper threshold is selected in a range between 55% and 65% of the requested value of the bus voltage.

### BRIEF DESCRIPTION OF THE SEVERAL VIEWS OF THE DRAWINGS

The embodiments of the present disclosure will now be described with reference to the annexed plates of drawings, which are provided purely to way of non-limiting example and in which:

The features and advantages of the present disclosure will become apparent from the following detailed description of practical embodiments thereof, shown by way of non-limiting example in the accompanying drawings, in which:

FIG. 1 shows a first example of a two-stage power supply comprising a PFC converter stage and a DC/DC converter stage;

FIGS. 2A and 2B show an example of a PFC boost converter;

FIG. 3 shows an example of a generic DC/DC electronic converter;

FIG. 4 shows a second example of a two-stage power supply;

FIG. 5 shows an embodiment of a two-stage power supply configured to generate an auxiliary supply voltage;

FIG. 6 shows an embodiment of a two-stage power supply comprising a power supply control circuit;

FIG. 7 shows an embodiment of a flyback DC/DC electronic converter;

FIG. 8 shows an embodiment of an output voltage estimation circuit;

FIG. 9 shows an embodiment of an output power estimation circuit; and

FIG. 10 shows an embodiment of the operation of the power supply control circuit of FIG. 6.

### DETAILED DESCRIPTION

In the ensuing description, various specific details are illustrated aimed at enabling an in-depth understanding of the embodiments. The embodiments may be provided without one or more of the specific details, or with other methods, components, materials, etc. In other cases, known structures, materials, or operations are not shown or described in detail so that various aspects of the embodiments will not be obscured.

Reference to “an embodiment” or “one embodiment” in the framework of this description is meant to indicate that a particular configuration, structure, or characteristic described in relation to the embodiment is comprised in at least one embodiment. Hence, phrases such as “in an embodiment”, “in one embodiment”, or the like that may be present in various points of this description do not necessarily refer to one and the same embodiment. Moreover, particular conformations, structures, or characteristics may be combined in any adequate way in one or more embodiments.

The references used herein are only provided for convenience and hence do not define the sphere of protection or the scope of the embodiments.

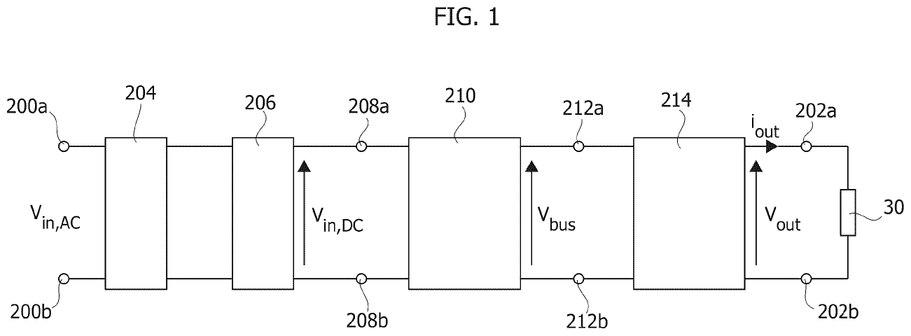

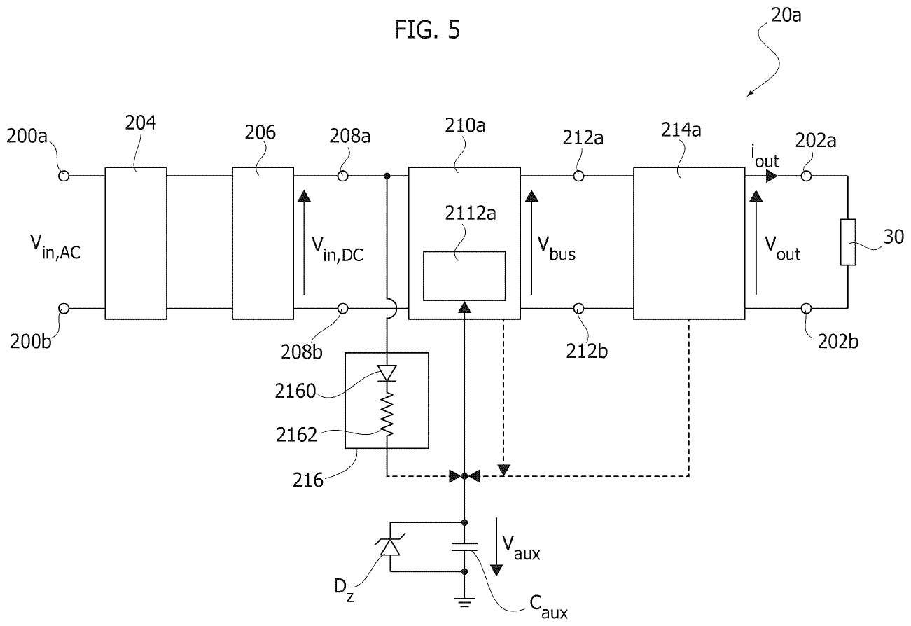

In FIGS. 5 to 10 described below, parts, elements or components that have already been described with reference to FIGS. 1 to 4 are designated by the same references used previously in these figures. The description of these elements has already been made and will not be repeated in what follows in order not to burden the present detailed description.

As described in the foregoing, in many applications, a power supply indeed comprises two electronic converters, wherein the first stage implements a PFC electronic converter 210. In fact, in the absence of such a PFC converter, the electronic converter 214 would be connected directly to the rectified input voltage V_{in,DC}.

In this case is usually used a larger input capacitor CIN in order to stabilize the DC voltage V_{in,DC} and supply the downstream switching converter 214. In fact, the input capacitor CIN needs to supply sufficient power during each half-cycle of the input voltage Vᵢₙ. Unfortunately, when using a larger input capacitor CIN, the line current i_{in,DC} is usually not anymore sinusoidal, and comprises high peak values. This implies a significant reduction of the power factor and the resulting high harmonic content causes distortion and line noise. Conversely, when using a PFC stage 210, this stage tries to synchronize the profile of the line current i_{in,DC} with the (half-sinusoidal) profile of the voltage V_{in,DC}, thereby improving the power factor of the converter.

A high power-factor also permits to reduce the peak-current and thus permits, e.g., to improve the efficiency of energy transportation, transmission and distribution, the size of the cables (especially neutral cable in three-phase systems) and the power transformers can be reduced. Similarly, by avoiding high current pulses, malfunction of network protection devices may be avoided. Finally, less current is required for the same power or, vice versa more power is available at the wall sockets with the same current. For these reasons, the harmonic current emissions of low-power commercially available equipment with input current ≤16 A per phase, should be limited, as described, e.g., in the reference standard IEC61000-3-2. For example, standard IEC61000-3-2 identifies four different classes, in which the devices connected to the power grid are divided:
A: Equipment not belonging to class B, C or D (audio equipment, household appliances, balanced three-phase equipment, professional luminaires for stage lighting and studios, etc.);
B: Portable tools, arc welding non-professional equipment;
C: Lighting equipment (lamps and luminaires) with input active power ≥5 W; and
D: IT equipment (PC, PC monitor, printer, ac adapter for laptop PC, etc.), TV receivers, some types of refrigerators and freezers, with input active power ≥75 W and ≤600 W.

One of the main disadvantages of using the PFC pre-regulator, is that the overall efficiency of this two-stages architecture is reduced (the total efficiency if given by the product of the efficiency of any single stage) and this requires specific control strategies to limit the inefficiency of the system. For example, as mentioned before, in prior-art solutions the efficiency of the system is usually improved by activating at light load conditions a burst mode for the PFC stage 210, whereby the PFC stage still generates a regulated output voltage V_{bus}. However, in this case, the control circuit of the PFC converter 210 must remain switched-on in order to manage the burst mode.

In this respect, power losses may be further reduced by switching off the PFC stage 210 at given load conditions. For example, for equipment belonging to class D (power adapters and chargers are included in this class), a PFC stage is not required when the input power is lower than 75 W. Accordingly, in this case, the power supply may be configured to:
switch on the PFC stage, when the power supply operates at an input power being greater than 75 W; and
switch off the PFC stage, when the power supply operates at an input power being smaller than 75 W.

For example, when using a PFC boost converter 210, the output capacitor COUT may be charged in this case via the diode SW2, whereby the output capacitor COUT may still supply the second stage electronic converter 214. However, in this case, the voltage V_{bus} at the capacitor COUT will have a ripple and will at most reach the value of the (rectified) input voltage V_{in,DC}, which may also correspond to a wide range of different mains voltages Vᵢₙ, e.g., ranging from 85 VAC to 264 VAC. For example, this implies that it may be complex to design an electronic converter 214, which has a high efficiency over the complete variable range of the voltage V_{bus}. In fact, in usual power supplies with PFC converter 210, the bus voltage V_{bus} generated by an activated PFC converter 210 is rather in the range of 400 V.

Moreover, the power supply has to correctly manage transients from light load to heavy load, because the PFC converter 210 may require some time to resume steady state operations, whereby the bus voltage V_{bus} may further decrease. For example, at low mains voltages (e.g., 110 VAC for an US input voltage), the bus voltage V_{bus} may fall below the permitted input voltage of the converter 214.

Accordingly, the converter 214 has to manage a wide range of load conditions and input voltages V_{bus}, whereby the converter 214 may be hardly optimized. For example, in case the converter 214 comprises a flyback converter with peak current mode control and constant switching periods T_{SW}, the wide operating range may imply that the duty cycle might exceed 50% during load transition, which leads to sub-harmonic instability. Conversely, in case the flyback converter 214 operates in quasi-resonant mode, i.e., with variable switching frequency, the primary peak current increases until an over-current protection might be triggered, resulting in a temporary loss of the output voltage regulation.

For this reason, the converter 214 has to use larger reactive components, e.g., in order to manage a higher Root-Mean Square (RMS) of the input current, which in turn causes higher conduction losses, e.g., due to higher power losses in the magnetic components. Similarly, a large capacitor COUT may be required in order to provide sufficient energy during load transitions.

Accordingly, simply switching off the PFC stage may be inefficient for the second stage converter 214. In this respect, improved solutions are known in the art. For example, Y. Jang, M. M. Jovanovic and D. L. Dillman, “Light-Load Efficiency Optimization Method”, 2009 Twenty-Fourth Annual IEEE Applied Power Electronics Conference and Exposition, Washington, DC, USA, 2009, pp. 1138-1144, doi: 10.1109/APEC.2009.4802806 propose a solution, wherein the PFC stage 210 is periodically activated and deactivated. Specifically, in this solution, the PFC converter is deactivated near the zero-crossings of the line voltage and is activated around the peaks of the line voltage. Accordingly, this solution permits to temporarily deactivate the PFC stage, while still obtaining a regulated bus voltage V_{bus}.

United State Patent Application Publication No. US 2015/0155776 A1 discloses a similar solution, wherein the PFC stage is deactivated near the zero crossing of the line voltage. However, in this case, the PFC stage 210 is activated for a given time period (centered on the instant of the peak value), wherein the time period (identified also as modulated phase angle) is determined as a function of the load condition.

The inventors have observed that the above solutions require additional circuits in order to determine the zero-crossing areas of the input voltage. Moreover, while the switching stage of the PFC converter 210 may be deactivated, the control circuit 2112 of the PFC converter 210 still remains enabled in order to regulate the bus voltage V_{bus}, thereby still generating power losses, which may be relevant at medium and in particular light load conditions.

In the following will now be described embodiments of solutions, which permit to improve the efficiency of the power supply, while also providing a suitable transient response.

FIG. 5 shows an embodiment of a power supply (power supply device) 20a configured to generate an auxiliary supply voltage Vₐᵤₓ. The power supply 20a essentially comprises the blocks already shown in FIG. 1, i.e.:
two input terminals 200a and 200b configured to receive an AC input voltage V_{in,AC};
a rectifier circuit 206 and an optional filter circuit 204 configured to generate a rectified input voltage V_{in,DC};
a PFC electronic converter 210a configured to receive the DC voltage V_{in,DC} an generate a regulated DC voltage V_{bus}, and
a further DC/DC electronic converter 214a configured to receive via the voltage V_{bus} and generate at two output terminals 202a and 202b a regulated output voltage Vₒᵤₜ or a regulated output current iₒᵤₜ.

As described in the foregoing, the PFC electronic converter 210a, e.g., implemented via a boost converter, comprises a control circuit 2112a configured to drive one or more electronic switches of the PFC electronic converter 210a as a function of the voltage V_{bus}, and optionally a signal indicative of the phase of the oscillation of the AC input voltage V_{in,AC}, e.g., the rectified input current i_{in,DC} or rectified input voltage V_{in,DC}.

In the embodiment considered, the control circuit 2112a of the PFC electronic converter 210a is not supplied via the voltage V_{in_DC} or the bus voltage V_{bus}, but a further DC voltage Vₐᵤₓ. In various embodiments, the voltage Vₐᵤₓ is generated via a further voltage source, e.g., receiving the voltage V_{in_DC}, the bus voltage V_{bus} and/or the output voltage Vₒᵤₜ, and/or the voltage Vₐᵤₓ is generated by the PFC electronic converter 210a and/or the electronic converter 214a.

For example, in line with United States Patent Application Publication No. US 2006/061337 A1, which is incorporated herein by reference for this purpose, the voltage Vₐᵤₓ may be provided via a capacitor Cₐᵤₓ.

In various embodiments, this capacitor Cₐᵤₓ is charged via a circuit 216 based on the rectified input voltage V_{in_DC}. For example, the circuit 216 may comprise a diode 2160 and a resistor 2162 connected in series between the terminal 208a and a first terminal of the capacitor, wherin the second terminal of the capacitor Cₐᵤₓ is connected to ground, e.g., corresponding to the terminals 208b or 212b. Accordingly, the capacitor Cₐᵤₓ is charged when an input voltage is applied to the input terminals 200a and 200b. In various embodiments, a Zener diode Dz or another voltage limiter circuit may be connected to the capacitor Cₐᵤₓ in order to limit the voltage at the capacitor Vₐᵤₓ to a maximum value.

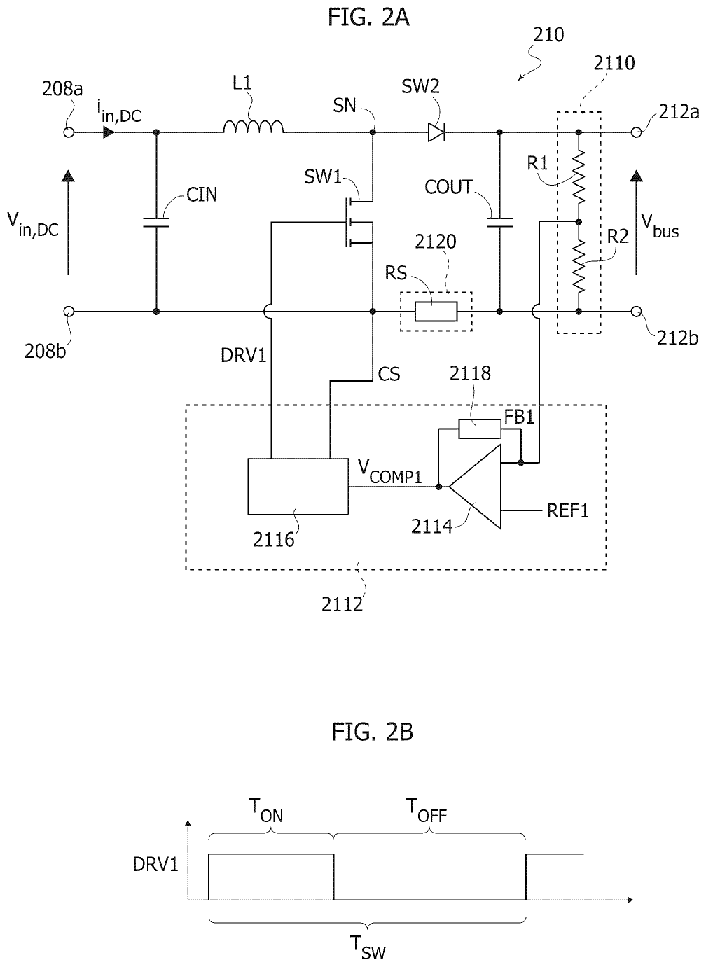

In various embodiments, the circuit 216 may be used mainly or only during a pre-charge phase. In this case, once the converter 210a and/or the converter 214a is operating/switching, the capacitor Cₐᵤₓ is charged via the converter 210a and/or the converter 214a. For example, when using a PFC boost converter, the inductor L1 shown in FIG. 2A may be replaced with the primary winding of a transformer, wherein an additional rectifier circuit (e.g., implemented with a diode) is connected between the secondary winding of the transformer and the capacitor Cₐᵤₓ. Additionally or alternatively the capacitor Cₐᵤₓ may be charged via the electronic converter 214a. For example, when using flyback converter 214a, the transformer of the flyback converter 214a may comprise a further auxiliary winding, wherein an additional rectifier circuit (e.g., implemented with a diode) is connected between the auxiliary winding of the transformer and the capacitor Cₐᵤₓ.

In various embodiments, the supply voltages for the control circuits 2112a and optionally 2144a may thus correspond to, or may be generated based on, the voltage Vₐᵤₓ. For example, an additional voltage regulator, such as a linear regulator, may be used to generate the supply voltages for the control circuit 2112a and optionally for the control circuit 2112a. Typically, such additional voltage regulators are included in the integrated circuit comprising the respective control circuit.

Such solutions for generating the supply voltage Vₐᵤₓ for the control circuit 2112a of the PFC converter 210a and optionally also for the control circuit 2144 of the electronic converter 214a are well-known in the art.

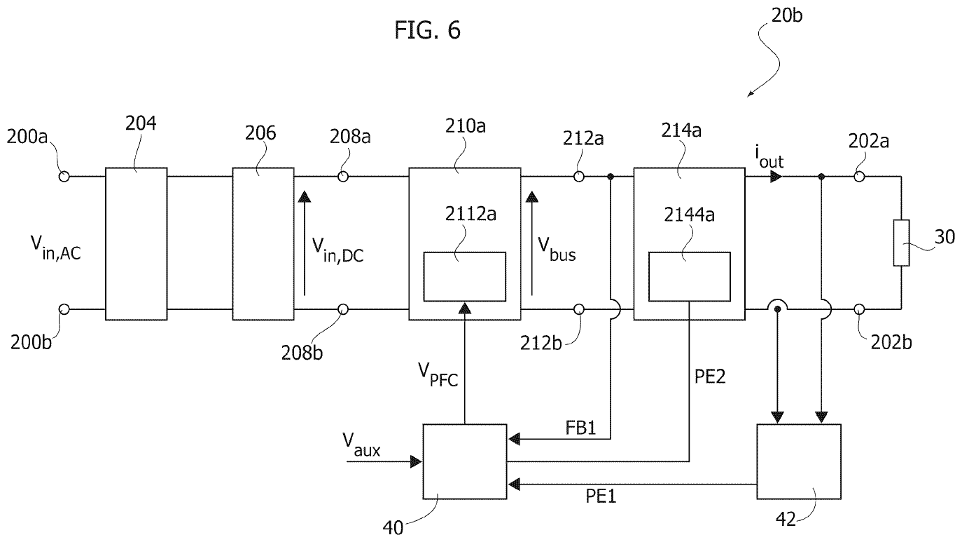

FIG. 6 shows an embodiment of a power supply 20b according to the present disclosure. Specifically, also the power supply 20b comprises:
two input terminals 200a and 200b configured to receive an AC input voltage V_{in,AC};
a rectifier circuit 206 and an optional filter circuit 204 configured to generate a rectified input voltage V_{in,DC};
a PFC electronic converter 210a configured to receive the DC voltage V_{in,DC} an generate a regulated DC voltage V_{bus}, and
a further DC/DC electronic converter 214a configured to receive via the voltage V_{bus} and generate at two output terminals 202a and 202b a regulated output voltage Vₒᵤₜ or a regulated output current iₒᵤₜ.

For a general description of these circuits reference is made to the description of FIGS. 1 to 3 and 5. In the embodiments considered, the power supply 20b is again configured to generate an auxiliary DC voltage Vₐᵤₓ. As described with respect to FIG. 5, such a DC voltage Vₐᵤₓ may be generated, e.g., via one or more circuits 216 receiving the rectified input voltage V_{in_DC}, the bus voltage V_{bus} and/or the output voltage Vₒᵤₜ. Additionally, the voltage Vₐᵤₓ may be generated by the PFC electronic converter 210a and/or the electronic converter 214a. For example, in various embodiments, the voltage is provided via a capacitor Cₐᵤₓ, which is charged via a pre-charge circuit 216 and (at least) via the electronic converter 214a. Optionally a voltage limiter circuit, such as a Zener diode Dz, is configured to limit the voltage at the capacitor Cₐᵤₓ.

In various embodiments, the control circuit 2144a of the electronic converter 214a may be supplied directly with the voltage Vₐᵤₓ or a voltage obtained from the auxiliary voltage Vₐᵤₓ. For example, in various embodiments, (the integrated circuit of) the control circuit 2144a may comprise an additional internal voltage regulator receiving the voltage Vₐᵤₓ.

Conversely, the supply voltage V_{PFC} of the control circuit 2112a of the PFC converter 210a is generated via a power supply control circuit 40 as a function of the voltage Vₐᵤₓ, the bus voltage V_{bus} and a control signal PE indicating whether the output power Pₒᵤₜ supplied by the power supply 20b is above or below a given threshold value. In various embodiments, (the integrated circuit of) the control circuit 2112a may comprise an additional internal voltage regulator receiving the voltage V_{PFC}.

As mentioned before, the circuit 40 also receives a control signal PE indicating whether the output power supplied by the power supply 20b (i.e., the power supplied via the terminals 2002a and 2002b) is above or below a given threshold value. For example, in various embodiments, the control circuit 40 may receive a control signal PE1 indicating whether the power Pₒᵤₜ provided via the terminals 202a and 202b is above or below a given input power threshold. For example, in the embodiment considered, the signal PE1 is provided by an output power estimation circuit 42 configured to determine a signal indicative of (and preferably proportional to) the output power, e.g., by monitoring the voltage Vₒᵤₜ at the terminals 202a and 202b, and the output current iₒᵤₜ provided via the terminals 202a and 202b. Accordingly, in various embodiments the circuit 42 may generate the signal PE1 by comparing the estimated output power Pₒᵤₜ with an output power threshold.

Instead of monitoring explicitly the output power Pₒᵤₜ, the power estimation circuit 42 may be also configured to monitor other power levels indicative of the output power Pₒᵤₜ, such as the power provided to the electronic converter 214a, e.g., by monitoring the voltage V_{bus} at the terminals 212a and 212b, and the respective current provided to the electronic converter 214a. Accordingly, in various embodiments the circuit 42 may generate the signal PE1 by comparing the estimated power provided to the converter 214a with a power threshold.

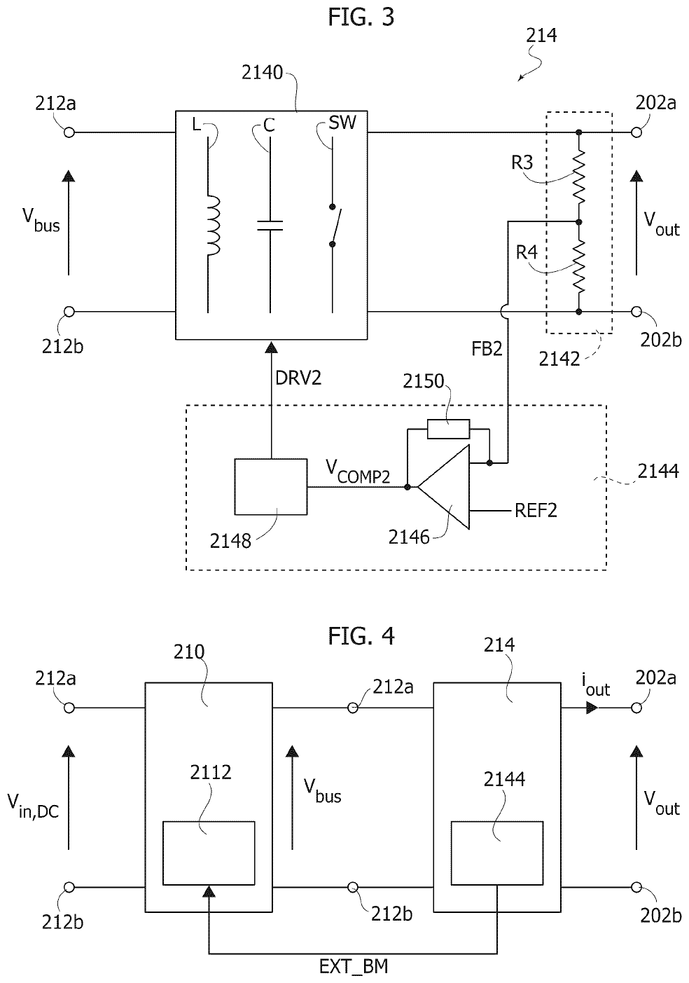

Instead of providing an additional power estimation circuit 42, the power supply 20b may also reuse existing signals. For example, in an electronic converter 214 as shown in FIG. 3, the error signals V_{COMP2} of the electronic converter 214a may already be indicative of a requested output power in order to obtain a requested output voltage Vₒᵤₜ (in case of a regulated voltage generator) or requested output current iₒᵤₜ (in case of a regulated current generator). Accordingly, in this case, the control circuit 2144a or a further circuit may generate a signal PE2 by comparing the error signals V_{COMP2} with a threshold.

Moreover, in case of a regulated voltage generator the output voltage Vₒᵤₜ corresponds to a requested value. Accordingly, in various embodiments, the power supply 20b, e.g., the control circuit 2144a or the power estimation circuit 42, is configured to monitor the output current iₒᵤₜ and generate the signal PE by comparing the measured output current iₒᵤₜ with a current threshold. Similarly, in case of a regulated current generator the output current iₒᵤₜ corresponds to a requested value. Accordingly, in various embodiments, the power supply 20b, e.g., the control circuit 2144a or the power estimation circuit 42, is configured to monitor the output voltage Vₒᵤₜ and generate the signal PE by comparing the measured output voltage Vₒᵤₜ with a voltage threshold.

Accordingly, in various embodiments, the power supply circuit 20b, e.g., the control circuit 2144a or the power estimation circuit 42, is configured to monitor one or more signals indicative of the power Pₒᵤₜ provided by the power supply circuit 20b, such as the output power or the power provided to the converter 214a, and generate a control signal PE indicating whether the one or more signals indicate that the power Pₒᵤₜ provided by the power supply circuit 20b is above or below a power threshold, i.e., the signal PE is set to a first logic level when the power Pₒᵤₜ provided by the power supply circuit 20b is above the power threshold and a second logic level when the power Pₒᵤₜ provided by the power supply circuit 20b is below the power threshold. For example, in various embodiments, the signal PE may be generated by the control circuit 2144a of the electronic converter 214a and may correspond to the external burst mode signal EXT_BM described in document U.S. Pat. No. 6,222,746 B1. Alternatively, a separate output power estimation circuit 42 may be provided.

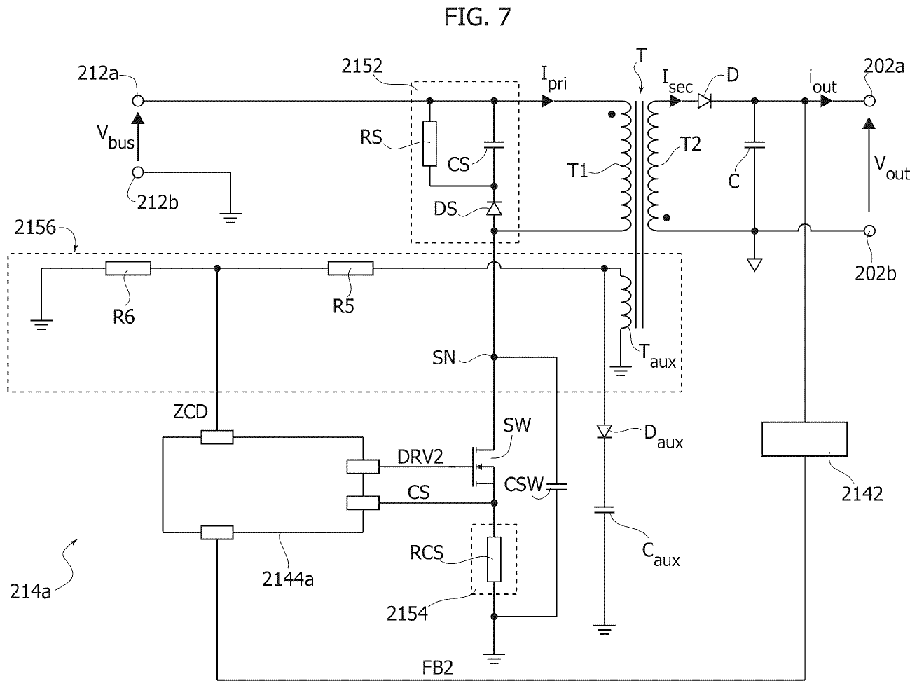

For example, FIG. 7 shows an embodiment of the electronic converter 214a based on a flyback converter. A flyback converter comprises a transformer T comprising a primary winding T1 and a secondary winding T2. Specifically, a first terminal of the primary winding T1 is connected (e.g., directly) to the (positive) input terminal 212a and a second terminal of the primary winding T1 is connected (e.g., directly) via (the current path of) an electronic switch SW to the (negative) input terminal 212b, which often represents a ground. Accordingly, the electronic switch SW is configured to selectively connect the primary winding to the input terminals 212a and 212b, i.e., the bus voltage V_{bus}. For example, in the embodiments considered, the electronic switch SW is implemented with a n-channel Field Effect Transistor (FET), such as a n-channel Metal-Oxide-Semiconductor Field-Effect Transistor (MOSFET), i.e., a NMOS. In this case, the drain terminal of the transistor SW is connected to the second terminal of the primary winding T1, representing a switching node SN of the flyback converter, and the source terminal of the transistor SW is connected to the terminal 212b.

Moreover, in the embodiment considered, a diode D and the secondary winding T2 are connected (e.g., directly) in series between the output terminals 202a and 202b. For example, a first terminal of the secondary winding T2 may be connected (e.g., directly) via the diode D to the (positive) output terminal 202a and a second terminal of the secondary winding T2 may be connected (e.g., directly) to the (negative) output terminal 202b. Generally, in addition or as alternative to the diode D may be used an electronic switch. Accordingly, the diode (and/or the electronic switch) D is configured to selectively connect the secondary winding T2 to the output terminals 202a and 202b. Moreover, a capacitor C is often connected (e.g., directly) between the terminals 202a and 202b.

As well-known, a conventional flyback converter 214a is operated via a control circuit 2144a essentially configured to drive the electronic switch SW with a respective drive signal DRV2 in order to regulate the output voltage Vₒᵤₜ or the output current iₒᵤₜ provided via the terminals 202a and 202b to a given reference value. For example, for this purpose the control circuit 2144a is configured to drive the switch SW periodically with two switching states having respective durations T_{ON} and T_{OFF}. During the interval T_{ON}, when the switch SW is closed and the diode/switch D is opened, the primary winding T1 of the transformer T1 is (directly) connected to the input voltage Vᵢₙ. Accordingly, the primary current Iₚᵣᵢ and the magnetic flux in the transformer T increases, thereby storing energy in the transformer T. In this condition, the capacitor C supplies energy to the output terminals 202a and 202b, i.e., the load 30. Conversely, during the interval T_{OFF}, when the switch SW is opened and the diode/switch D is closed, the primary current Iₚᵣᵢ drops to zero, while a secondary side current I_{sec} starts flowing in the secondary winding, and the energy from the transformer core T recharges the capacitor C and supplies the load 30.

In various embodiments, the flyback converters 214a comprises also a snubber/clamp circuit 2152. For example, in the embodiment considered, the clamp circuit 2152 is connected in parallel with the primary winding T1 of the transformer T, and comprises a series connection of a clamp capacitor CS and a diode DS, i.e., the clamp capacitor CS and the diode DS are connected in series between the terminals of the primary winding T1. Generally, in addition or as alternative to the diode DS may be used an electronic switch. Often a resistor RS is connected (e.g., directly) in parallel with the capacitor CS. Accordingly, the diode/switch DS is configured to selectively connect the capacitor CS (and optionally the resistor RS) in parallel with the primary winding T1. Substantially, the addition of the capacitor CS and the diode/switch DS permits to deviate the energy in the leakage inductance L_{S} into the clamp capacitor CS. Specifically, when the control circuit 210 turns off the electronic switch SW, the switching node SN (between the primary winding T1 and the electronic switch SW, e.g., the drain terminal of the transistor SW) rises as in a normal flyback converter (without clamp). Anyway, when the voltage at the switching node SN bypasses the voltage at the clamp capacitor CS, the diode/switch DS turns on and the primary current Iₚᵣᵢ flows also to the capacitor CS until the primary current Iₚᵣᵢ drops to zero. When using a switch DS, the energy stored on the capacitor CS may be given back to the system by turning on the electronic switch DS. Alternatively, the capacitor CS may discharge via the resistor RS.

As mentioned before, the control circuit 2144a is configured to generate a drive signal DRV2 for the electronic switch SW connected in series with the primary winding T1 between the terminals 212a and 212b, wherein the intermediate node between the primary winding T1 and the electronic switch SW represents the switching node SN, wherein a capacitance CSN is associated with the switching node SN, which is schematically shown via a capacitance connected between the switching node SN and the terminal 212b (ground). Generally, the capacitance CSN comprises the parasitic capacitance CSW of the electronic switch SW, possible other parasitic capacitances (e.g., of the traces of a respective printed circuit board) and optionally one or more capacitors connected to the switching node SN.

In the embodiment considered, the control circuit 2144a has associated:
a feedback circuit 2142 configured to provide a feedback signal FB2 indicative of the output quantity to be regulated, e.g., the output voltage Vout; and
a current measurement circuit 2154 configured to generate a signal CS indicative of (e.g., proportional to) the current Iₚᵣᵢ flowing through the primary winding T1 (at least) during the switch-on period T_{ON}.

For example, in FIG. 7, the current measurement circuit 2154 is implemented with a current sensor, such as a resistor RCS, connected in series with the switch SW, e.g., between the source terminal of a respect n-channel FET SW, and the terminal 212b (ground), wherein the voltage (corresponding to the signal CS) at the resistor RCS is proportional to the current flowing through the switch SW.

Accordingly, in various embodiments, the control circuit 2144a is configured to generate the drive signal DRV2 as a function of the signals CS and FB2. Specifically, when using a peak-current control with constant switching frequency, the control circuit 2144a may:
open the electronic switch SW, e.g., set the signal DRV2 to low, when the signal CS reaches a given reference value, wherein the reference value is determined as a function of the feedback signal FB2; and
close the electronic switch SW after a fixed switching period T_{SW}.

In various embodiments, the feedback circuit 2142 or the control circuit 2144a may thus implement a regulator having at least an integral (I) component, whereby the reference value for the comparison with the signal CS is increase/decreased until the output quantity (Vₒᵤₜ or Iₒᵤₜ) corresponds to a given requested value.

In various embodiments, the control circuit comprises also a valley monitoring circuit 2156, configured to generate a signal ZCD indicative of the valleys in the voltage V_{SN} at the switching node SN, such as a demagnetization monitoring circuit configured to generate a signal indicative of magnetization and demagnetization of the transformer T (at least) during the switch-off period T_{OFF}. For example, in the embodiment considered, the valley/demagnetization monitoring circuit 2156 is implemented with an auxiliary winding of the transformer T. In the embodiment considered, the demagnetization monitoring circuit 2156 comprises also an optional voltage divider, e.g., implemented with two resistors R5 and R6 connected (e.g., directly) in series between the terminals of the auxiliary winding Taux, wherein preferably one of the terminals of the auxiliary winding Taux is connected to the terminals 212b (ground). Thus, in the embodiment considered, the voltage at the resistor R6 (corresponding to the signal ZCD) is proportional to the voltage at the terminals of the auxiliary winding Taux. Specifically, the voltage at the auxiliary winding Taux is proportional to:
the input voltage Vᵢₙ, when the switch SW is closed and the diode/switch D is opened, i.e., during the switch on period T_{ON};
the output voltage Vₒᵤₜ, when the switch SW is opened and the diode/switch D is closed, i.e., during the first part of the switch off period T_{OFF} when the current I_{sec} is positive and charges the output capacitor C; and
the magnetization of the transformer T, when the switch SW is opened and the diode/switch D is opened, i.e., during the second part of the switch off period T_{OFF} when the current I_{sec} is zero, whereby the inductances of the transformed T oscillate with the capacitances at the primary side.

Accordingly, when using a valley switching or quasi resonant (QR) switching, the control circuit 2112a may be configured to:
open the electronic switch SW, e.g., set the signal DRV2 to low, when the signal CS reaches a given reference value, wherein the reference value is determined as a function of the feedback signal FB2; and
close the electronic switch SW, e.g., set the signal DRV2 to high, when the signal ZCD reaches zero or becomes negative, which indicates a valley in the voltage V_{SN}/a demagnetization of the transformer T.

Also in this case, the feedback circuit 2142 or the control circuit 2144a may implement a regulator having at least an integral (I) component, whereby the switch SW is switched off at a given peak value of the current Iₚᵣᵢ and switched on at one of the valley points of the voltage at the switching node. Specifically, in such a QR flyback converter, the switching activity is achieved by synchronizing the turn-on of the switch SW with the valley of the voltage V_{SN}/transformer demagnetization, e.g., by detecting the resulting negative-going edge of the voltage across the auxiliary winding Taux of the transformer T, which is connected to a terminal of the control circuit 2144a, usually called zero-current detection pin (ZCD pin). Such flyback converters are well-known in the art. For example, for this purpose may be cited U.S. Pat. No. 11,482,945 B2, which is incorporated herein by reference.

In line with the description of FIG. 5, in various embodiments, the auxiliary winding Taux may also be used to charge the capacitor Caux providing the auxiliary voltage Vₐᵤₓ. For example, in FIG. 7, a diode Daux is connected between auxiliary winding Taux and the capacitor Cₐᵤₓ, thereby essentially implementing a further output stage of the flyback converter.

As mentioned before, in the embodiment considered, the voltage at the auxiliary winding Taux is indicative of the output voltage Vₒᵤₜ during the first part of the switch-off period T_{OFF}: Thus, in order to generate the signal PE, the control circuit 1142a or a separate power estimation circuit 42 may monitor the voltage at the auxiliary winding Taux or the resistor R6.

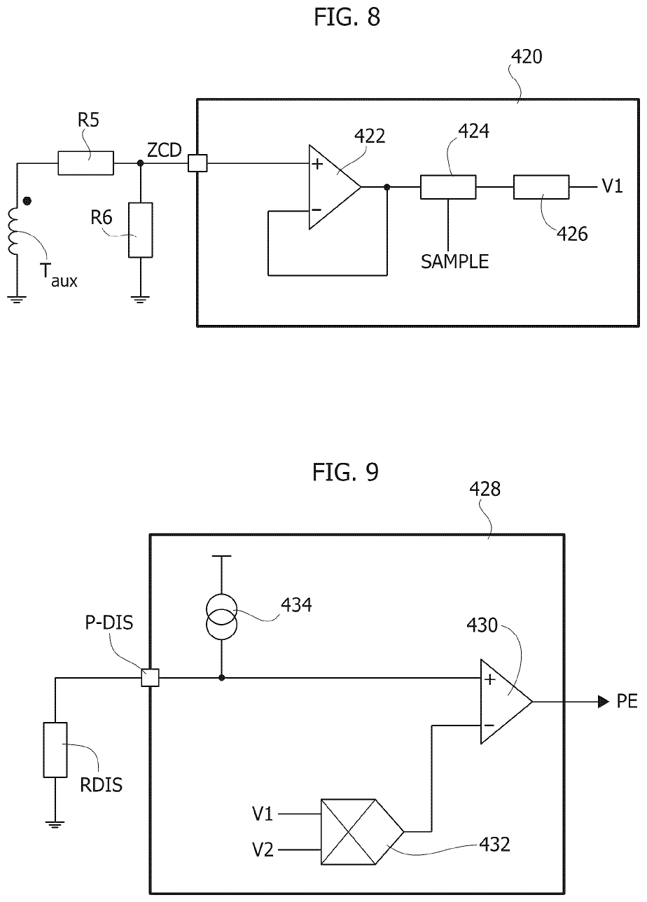

For example, FIG. 8 shows an embodiment of an output voltage estimation circuit 420, possibly implemented within the control circuit 1142a or the circuit 42, configured to generate a signal V1 indicative of (and preferably proportional to) the output voltage Vₒᵤₜ. Specifically, in the embodiment considered, the circuit 420 comprises terminal ZCD configured to receive the voltage at the auxiliary winding Taux or at the resistor R6, and an analog sample-and-hold circuit 424 configured to generate the signal Vₒᵤₜ′ by storing the voltage received via the terminal ZCD in response to a signal SAMPLE. As mentioned before, the voltage at the auxiliary winding Taux is proportional to the output voltage Vₒᵤₜ, when the switch SW is opened and the diode/switch D is closed, i.e., during the first part of the switch off period T_{OFF} when the current I_{sec} is positive and charges the output capacitor C. Accordingly, the sampling signal SAMPLE may correspond to a trigger signal, which is asserted while the current I_{sec} is positive. For example, in CCM operated converters, the signal SAMPLE may be asserted at the end of the switch off period T_{OFF}, e.g., just before the switch SW is turned ON. Conversely, in DCM or in QR operated converters, the signal SAMPLE may be asserted at the instant when the secondary current I_{sec} goes to zero. For example, this instant can be detected either by directly measuring the secondary current I_{sec} or, as mentioned before, at the falling edge instant of the voltage across the ZCD pin.

In various embodiments, a voltage follower, or an amplifier 422 may be connected between the terminal ZCD and the sample-and-hold circuit 424. Moreover, in various embodiments, the circuit 42 comprises an amplifier 426 configured to generate the signal V1 by amplifying the signal at the output of the sample-and-hold circuit 424.

In various embodiments, the circuit 420 may comprise also an analog-to-digital converter (ADC). For example, the circuit 422 may be replaced with an ADC and the analog-to-digital conversion may be triggered via the signal SAMPLE. Accordingly, in the case, the signal V1 is a digital sample being indicative of the output voltage.

Similarly, may be used a circuit to generate an analog of digital signal indicative of the output current iₒᵤₜ. For example, document F. Cacciotto, C. Adragna, “Feasibility Study on a Novel Robust Current-mode Method”, IEEE Applied Power Electronics Conference and Exposition—APEC, 2023, March 2023, which is incorporated herein by reference for this purpose, discloses a solution for generating a signal (V2) estimating the output current as a function of the feedback signal FB2 of the electronic converter.

Accordingly, as shown in FIG. 9, when explicitly estimating the output power Pₒᵤₜ, the control circuit 1142a or the circuit 42 may comprise a circuit 428 configured to generate the signal PE as a function of the voltage V1 indicative of the (measure or estimated) output voltage Vₒᵤₜ, the voltage V2 indicative of the (measure or estimated) output current iₒᵤₜ and a threshold voltage V_{TH}.

For example, in the embodiment considered, the (analog or digital) signals V1 and V2 are provided to an (analog or digital) multiplier 432, which this generates a signal indicative of the output power Pₒᵤₜ. The signal at the output of the multiplier and a threshold signal V_{TH} are thus provided to an (analog or digital) comparator 430 configured to set the signal PE to a first logic level when the signal at the output of the multiplier 430 is greater than the threshold voltage V_{TH} and to a second logic level when the signal at the output of the multiplier 430 is smaller than the threshold voltage V_{TH}.

For example, in the embodiment considered, the threshold signal corresponds to a threshold voltage V_{TH}, which is set via a set resistor RDIS. For example, in the embodiment considered, the circuit 428 comprises a current source 434 configured to apply a current to a node P-DIS. Accordingly, by connecting a resistor RDIS to the node P-DIS, the current provided by the current source 434 generates a voltage drop being proportional to the resistance of the resistor RDIS. Accordingly, by using the voltage at the node P-DIS as threshold voltage V_{TH}, the resistor RDIS may be used to set the threshold voltage V_{TH}. In various embodiments, the resistor RDIS is external with respect to the integrated circuit comprising the circuit 428, e.g., the node P-DIS may be a pad (of a die) or a pin (of a packaged die) of the integrated circuit comprising the circuit 42 or the control circuit 1142a.

In case of a regulated output current iₒᵤₜ or a regulated output voltage Vₒᵤₜ, the comparator 430 may compare the threshold signal V_{TH} also directly with the signal V1 (indicative of the output voltage Vₒᵤₜ) or the signal V2 (indicative of the output voltage iₒᵤₜ), respectively.

As mentioned before, the signal PE is used by the power control circuit 40. In general, the power control circuit 40 may be integrated in the IC of the power estimation circuit 42 or the control circuit 2144a. For example, in various embodiments, the power estimation circuit 42 and the power control circuit 40 are implemented in the integrated circuit of the control circuit 2144a, such as a control circuit of a flyback converter.

Specifically, in various embodiments, in response to determining that the signal PE indicates that the output power Pₒᵤₜ is above the power threshold, i.e., at high load conditions, the power supply control circuit 40 is configured to switch on the control circuit 2112a by providing the voltage Vₐᵤₓ as voltage V_{PFC} to the control circuit 2112a. Conversely, in response to determining that the signal PE indicates that the output power Pₒᵤₜ is below the power threshold, i.e., at light load conditions, the power supply control circuit 40 is configured to selectively switch on and off the control circuit 2112a as a function of the bus voltage V_{bus}. Specifically, for this purpose, the power supply control circuit 40 is configured to:
switch on the control circuit 2112a by providing the voltage Vₐᵤₓ as voltage V_{PFC} to the control circuit 2112a, in response to determining that bus voltage V_{bus} (reaches or) is below a lower threshold; and
switch off the control circuit 2112a by disconnecting the voltage V_{PFC} from the voltage Vₐᵤₓ, in response to determining that bus voltage V_{bus} (reaches or) is above an upper threshold.

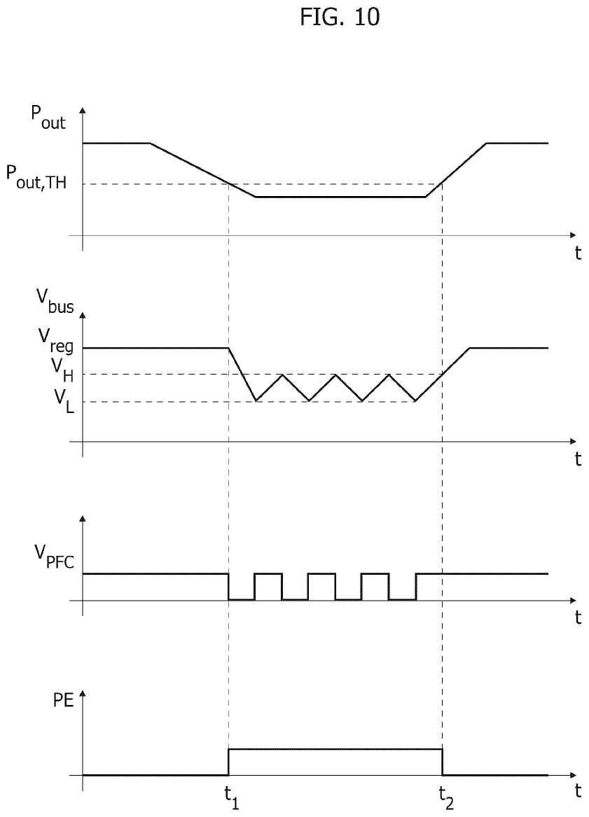

For example, this is also shown in FIG. 10. Specifically, initially the power supply 20b provides a high output power Pₒᵤₜ, whereby the comparator circuit 430 sets the signal PE to a first value (e.g., low) indicating that the output power Pₒᵤₜ is above the power threshold, indicated in FIG. 10 as P_{out,TH}. Accordingly, since the signal PE has the first value, the power supply control circuit 40 supplies the control circuit 2112a with the voltage Vₐᵤₓ, e.g., by connecting the voltage V_{PFC} to the voltage Vₐᵤₓ, wherein the control circuit 2112a regulates the bus voltage V_{bus} to a requested value, indicated in FIG. 10 as V_{reg}.

In the example considered, the output power then decreases, e.g., gradually, whereby the output power falls below the power threshold P_{out,TH} at an instant t₁. Accordingly, in response to determining that the output power falls below the power threshold P_{out,TH}, the comparator 430 sets the signal PE to a second value (e.g., high) indicating that the output power Pₒᵤₜ is below the power threshold.

Specifically, in this mode of operation, the power supply control circuit 40 is configured to:
supply the control circuit 2112a with the voltage Vₐᵤₓ, e.g., by connecting the voltage V_{PFC} to the voltage Vₐᵤₓ, in response to determining that the bus voltage V_{bus} reaches (or is smaller than) a lower threshold, indicated in FIG. 10 as voltage V_{L}; and
do not supply the control circuit 2112a with the voltage Vₐᵤₓ, e.g., by connecting the voltage V_{PFC} to ground or in general disconnecting the voltage V_{PFC} from the voltage Vₐᵤₓ, in response to determining that the bus voltage V_{bus} reaches (or is greater than) an upper threshold, indicated in FIG. 10 as voltage V_{H}.

Accordingly, even when the signal PE has the second value and the control circuit 2112a is switched on, the control circuit 2112a will try to regulate the bus voltage V_{bus} to the requested value V_{reg}. However, once the bus voltage V_{bus} reaches the upper threshold V_{H}, the power supply control circuit 40 switches off the power supply of the control circuit 2112a. Accordingly, at this stage, the control circuit 2112a is switched-off and the PFC converter 210a is de-activated, whereby the bus voltage V_{bus} decreases. However, once the bus voltage V_{bus} reaches the lower threshold V_{L}, the power supply control circuit 40 switches on the power supply of the control circuit 2112a, whereby the PFC converter 210a is activated and increases again the bus voltage V_{bus}.

In the example considered, the output power then increases, e.g., gradually, whereby the output power exceeds the power threshold P_{out,TH} at an instant t₂. Accordingly, in response to determining that the output power exceeds the power threshold P_{out,TH}, the comparator 430 sets the signal PE to the first value (e.g., low) indicating that the output power Pₒᵤₜ is above the power threshold. Accordingly, in response to determining that the signal PE has the first value, the power supply control circuit 40 supplies the control circuit 2112a with the voltage Vₐᵤₓ, e.g., by connecting the voltage V_{PFC} to the voltage Vₐᵤₓ, wherein the control circuit 2112a regulates the bus voltage V_{bus} to the requested value as V_{reg}.

Specifically, in various embodiments, the threshold value V_{H} is smaller than the requested/regulation voltage V_{reg}, and the threshold value V_{L} is smaller than the threshold value V_{H}. For example, as mentioned before, in various embodiments, the requested/regulation value V_{reg} for the bus voltage V_{bus} is selected in a range between 300 and 500 V, preferably between 370 and 430 V, such as (approximately) 400 V. In various embodiments, the upper threshold V_{H} is selected in a range between 40% and 70% of the requested/regulation value V_{reg}, for example, (approximately) 0.6 V_{reg}. Finally, the lower threshold V_{L} is selected in a range between 60% and 90% of the upper threshold V_{H}. For example, in various embodiments, the thresholds V_{L} is selected in a range between 45% and 55% of V_{reg} and upper threshold V_{H} is selected in a range between 55% and 65% of V_{reg}. The exact values of the thresholds (and the respective hysteresis) may depend on the specific design of the power converter, as well as the operative conditions.

Thus, also the solutions disclosed in the present disclosure drive the PFC converter with a sequence of pulses, similar to a burst mode. However, when using a burst mode, the respective threshold values would be selected near the requested/regulation value V_{reg}. Conversely, in the solutions disclosed herein are used lower threshold values, which ensure a bus voltage V_{bus}, which permit that the following electronic converter 214a still operates at a high efficiency and which is sufficient in order to supply the electronic converter 214a also during load transients from a light load condition to a heavy load condition. Moreover, compared to a burst mode, the control circuit 2112a of the PFC converter is completely switched off, without consuming any energy. In the respect, using lower thresholds at medium and light load conditions permits to reduce the switching losses (which are usually voltage-dependent) and increase the converter's efficiency.

Of course, without prejudice to the principle of the disclosure, the details of construction and the embodiments may vary widely with respect to what has been described and illustrated herein purely by way of example, without thereby departing from the scope of the present disclosure, as defined by the ensuing claims.

A power supply control circuit for a power supply, said power supply (20b) may be summarized as including: two input terminals (200a, 200b) configured to be connected to the mains for receiving an AC input voltage (V_{in,AC}); two output terminals (202a, 202b) configured to be connected to a load (30); a rectifier circuit (206) configured to generate a rectified input voltage (V_{in,DC}) from said AC input voltage (V_{in,AC}); a Power-Factor Correction, PFC, electronic converter (210a) configured to generate a bus voltage (V_{bus}) from said rectified input voltage (V_{in,DC}); an electronic converter (214a) configured to generate at said two output terminals (202a, 202b) a regulated output voltage (Vₒᵤₜ) or a regulated output current (iₒᵤₜ) from said bus voltage (V_{bus}); and an auxiliary power supply (Cₐᵤₓ, Dz, 216, Dₐᵤₓ) configured to generate an auxiliary supply voltage (Vₐᵤₓ); wherein said PFC electronic converter (210a) includes a PFC control circuit (2112a) including a terminal for received a supply voltage (V_{PFC}), and wherein said PFC control circuit (2112a) is configured, when supplied via said supply voltage (V_{PFC}), to drive said PFC electronic converter (210a) in order to regulate said bus voltage to a requested value (V_{reg}), wherein said power supply control circuit (40, 42) is configured to: generate a signal indicative of the output power (Pₒᵤₜ) provided via said two output terminals (202a, 202b); determine whether said signal indicates that the output power (Pₒᵤₜ) is greater than a threshold value (P_{out,TH}); in response to determining that said signal indicates that the output power (Pₒᵤₜ) is greater than said threshold value (P_{out,TH}), supply said PFC control circuit (2112a) with said auxiliary supply voltage (Vₐᵤₓ); and in response to determining that said signal indicates that the output power (Pₒᵤₜ) is smaller than said threshold value (P_{out,TH}): generate a signal indicative of said bus voltage (V_{bus}); determine whether said signal indicates that said bus voltage (V_{bus}) is greater than an upper threshold (V_{H}), and in response to determining that said signal indicates that said bus voltage (V_{bus}) is greater than said upper threshold (V_{H}), inhibit supply of said PFC control circuit (2112a) with said auxiliary supply voltage (Vₐᵤₓ), whereby said PFC control circuit (2112a) is switched off; and determine whether said signal indicates that said bus voltage (V_{bus}) is smaller than a lower threshold (V_{L}), and in response to determining that said signal indicates that said bus voltage (V_{bus}) is smaller than said lower threshold (V_{L}), supply said PFC control circuit (2112a) with said auxiliary supply voltage (Vₐᵤₓ).

Said auxiliary power supply (Cₐᵤₓ, Dz, 216, Dₐᵤₓ) may include a capacitor (Cₐᵤₓ) and a charge circuit (216) configured to charge said capacitor (Cₐᵤₓ) via said rectified input voltage (V_{in,DC}).

Said electronic converter (214a) may be a flyback converter including a transformer having an auxiliary winding (Taux), wherein said auxiliary winding (Taux) is connected via a diode (Dₐᵤₓ) to said capacitor (Cₐᵤₓ).

Said PFC electronic converter (210a) may be a boost converter including: a positive (208a) and a negative (208b) input terminal for receiving said rectified input voltage (V_{in,DC}); a positive (212a) and a negative (212b) output terminal for providing said bus voltage (V_{bus}); an inductance (L1) connected between said positive input terminal (208a) and a switching node (SN); an electronic switch (SW1) connected between said switching node (SN) and said negative terminal (208b); a further diode or further electronic switch (SW2) connected between said switching node (SN) and said positive output terminal (212a); a feedback circuit (2110) configured to generate a feedback signal (FB1) proportional to said bus voltage V_{bus}, wherein said PFC control circuit (2112a) is configured, when supplied via said supply voltage (V_{PFC}), to drive said electronic switch (SW1) and optionally said further electronic switch (SW2) in order to regulate said feedback signal (FB1) to a reference value (REF1).

Said generating a signal indicative of the output power (Pₒᵤₜ) provided via said two output terminals (202a, 202b) may include: estimating (420) a signal (V1) proportional to said output voltage (Vₒᵤₜ) and a signal (V2) proportional to said output current (iₒᵤₜ), and generating said signal indicative of the output power (Pₒᵤₜ) by multiplying (432) said signal (V1) proportional to said output voltage (Vₒᵤₜ) with said signal (V2) proportional to said output current (iₒᵤₜ); or estimating a signal proportional to said bus voltage (V_{bus}) and a signal proportional to the current provided to said electronic converter (214a), and generating said signal indicative of the output power (Pₒᵤₜ) by multiplying (432) said signal (V1) proportional to said output voltage (Vₒᵤₜ) with said signal (V2) proportional to said output current (iₒᵤₜ).

Said electronic converter (214a) may be configured to generate a regulated output voltage (Vₒᵤₜ), and said signal indicative of the output power (Pₒᵤₜ) is proportional to the output current (iₒᵤₜ) provided via said two output terminals (202a, 202b); or said electronic converter (214a) may be configured to generate a regulated output current (iₒᵤₜ), and said signal indicative of the output power (Pₒᵤₜ) is proportional to the output voltage (Vₒᵤₜ) at said two output terminals (202a, 202b).

The power supply control circuit (40, 42) may include estimating said output voltage (Vout) by sampling (424) the voltage at said auxiliary winding (Taux) during a switch-off period of said flyback converter.

Said power supply control circuit (40, 42) may include a terminal configured to be connected to a set resistor (RDIS), wherein said threshold value (P_{out,TH}) is defined via the resistance value of said set resistor (RDIS).

Said lower threshold (V_{L}) may be selected in a range between 45% and 55% of said requested value (V_{reg}), and said upper threshold (V_{H}) may be selected in a range between 55% and 65% of said requested value (V_{reg}).

Said electronic converter (214a) may include a control circuit (2142a), wherein said control circuit (2142a) and said power supply control circuit (40, 42) are integrated in the same integrated circuit.

A power supply (20a) may be summarized as including: two input terminals (200a, 200b) configured to be connected to the mains for receiving an AC input voltage (V_{in,AC}); two output terminals (202a, 202b) configured to be connected to a load (30); a rectifier circuit (206) configured to generate a rectified input voltage (V_{in,DC}) from said AC input voltage (V_{in,AC}); a Power-Factor Correction, PFC, electronic converter (214a) configured to generate a bus voltage (V_{bus}) from said rectified input voltage (V_{in,DC}); an electronic converter (214a) configured to generate at said two output terminals (202a, 202b) a regulated output voltage (Vₒᵤₜ) or a regulated output current (iₒᵤₜ) from said bus voltage (V_{bus}); an auxiliary power supply (Cₐᵤₓ, Dz, 216, Dₐᵤₓ) configured to generate an auxiliary supply voltage (Vₐᵤₓ); and a power supply control circuit (40, 42) according to any of the previous claims.

A method of operating a power supply (20a) may be summarized as including: generating a signal indicative of the output power (Pₒᵤₜ) provided via said two output terminals (202a, 202b); determining whether said signal indicates that the output power (Pₒᵤₜ) is greater than a threshold value (P_{out,TH}); in response to determining that said signal indicates that the output power (Pₒᵤₜ) is greater than a threshold value (P_{out,TH}), supplying said PFC control circuit (2112a) with said auxiliary supply voltage (Vₐᵤₓ); and in response to determining that said signal indicates that the output power (Pₒᵤₜ) is smaller than a threshold value (P_{out,TH}): generating a signal indicative of said bus voltage (V_{bus}); determining whether said signal indicates that said bus voltage (V_{bus}) is greater than an upper threshold (V_{H}), and in response to determining that said signal indicates that said bus voltage (V_{bus}) is greater than said upper threshold (V_{H}), inhibiting supply of said PFC control circuit (2112a) with said auxiliary supply voltage (Vₐᵤₓ), whereby said PFC control circuit (2112a) is switched off; and determining whether said signal indicates that said bus voltage (V_{bus}) is smaller than a lower threshold (V_{L}), and in response to determining that said signal indicates that said bus voltage (V_{bus}) is smaller than said lower threshold (V_{L}), supplying said PFC control circuit (2112a) with said auxiliary supply voltage (Vₐᵤₓ).

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A power supply control circuit for a power supply device, the power supply device comprising:
two input terminals configured to be coupled to mains for receiving an AC input voltage;
two output terminals configured to be coupled to a load;
a rectifier circuit configured to generate a rectified input voltage from the AC input voltage;
a Power-Factor Correction (PFC) electronic converter configured to generate a bus voltage from the rectified input voltage;
an electronic converter configured to generate at the two output terminals a regulated output voltage or a regulated output current from the bus voltage; and
an auxiliary power supply configured to generate an auxiliary supply voltage;
wherein the PFC electronic converter includes a PFC control circuit including a terminal for receiving a supply voltage, and wherein the PFC control circuit is configured, when supplied with the supply voltage, to drive the PFC electronic converter in order to regulate the bus voltage to a requested value,
wherein the power supply control circuit is configured to:
generate a signal indicative of an output power provided via the two output terminals;
determine whether the signal indicates that the output power is greater than a threshold value;
in response to determining that the signal indicates that the output power is greater than the threshold value, supply the PFC control circuit with the auxiliary supply voltage; and
in response to determining that the signal indicates that the output power is less than the threshold value:
generate a signal indicative of the bus voltage;
determine whether the signal indicates that the bus voltage is greater than an upper threshold, and in response to determining that the signal indicates that the bus voltage is greater than the upper threshold, inhibit supply of the PFC control circuit with the auxiliary supply voltage, whereby the PFC control circuit is switched off; and
determine whether the signal indicates that the bus voltage is less than a lower threshold, and in response to determining that the signal indicates that the bus voltage is less than the lower threshold, supply the PFC control circuit with the auxiliary supply voltage.

2. The power supply control circuit according to claim 1, wherein the auxiliary power supply includes a capacitor and a charge circuit configured to charge the capacitor via the rectified input voltage.

3. The power supply control circuit according to claim 2, wherein the electronic converter is a flyback converter including a transformer having an auxiliary winding, wherein the auxiliary winding is coupled via a first diode to the capacitor.

4. The power supply control circuit according to claim 1, wherein the PFC electronic converter is a boost converter including:
positive and negative input terminals for receiving the rectified input voltage;
positive and negative output terminals for providing the bus voltage;
an inductance coupled between the positive input terminal and a switching node;
a first electronic switch coupled between the switching node and the negative input terminal;
a second diode or second electronic switch coupled between the switching node and the positive output terminal; and
a feedback circuit configured to generate a feedback signal proportional to the bus voltage,
wherein the PFC control circuit is configured, when supplied via the supply voltage, to drive the first electronic switch in order to regulate the feedback signal to a reference value.

5. The power supply control circuit according to claim 4, wherein the PFC control circuit is configured, when supplied via the supply voltage, to drive the second electronic switch in order to regulate the feedback signal to the reference value.

6. The power supply control circuit according to claim 1, wherein generating the signal indicative of the output power provided via the two output terminals includes:
estimating a signal proportional to the output voltage and a signal proportional to the output current, and generating the signal indicative of the output power by multiplying the signal proportional to the output voltage with the signal proportional to the output current; or
estimating a signal proportional to the bus voltage and a signal proportional to the current provided to the electronic converter, and generating the signal indicative of the output power by multiplying the signal proportional to the output voltage with the signal proportional to the output current.

7. The power supply control circuit according to claim 1, wherein:
the electronic converter is configured to generate the output voltage, and the signal indicative of the output power is proportional to the output current provided via the two output terminals; or
the electronic converter is configured to generate the regulated output current, and the signal indicative of the output power is proportional to the output voltage at the two output terminals.

8. The power supply control circuit according to claim 3, wherein the power supply control circuit is configured to estimate the output voltage by sampling the voltage at the auxiliary winding during a switch-off period of the flyback converter.

9. The power supply control circuit according to claim 1, wherein the power supply control circuit comprises a terminal configured to be coupled to a set resistor, wherein the threshold value is defined via the resistance value of the set resistor.

10. The power supply control circuit according to claim 1, wherein the lower threshold is selected in a range between 45% and 55% of the requested value, and the upper threshold is selected in a range between 55% and 65% of the requested value.

11. The power supply control circuit according to claim 1, wherein the electronic converter includes a control circuit, wherein the control circuit and the power supply control circuit are integrated in the same integrated circuit.

12. A power supply device, comprising:
two input terminals configured to be coupled to mains for receiving an AC input voltage;
two output terminals configured to be coupled to a load;
a rectifier circuit configured to generate a rectified input voltage from the AC input voltage;
a Power-Factor Correction (PFC) electronic converter configured to generate a bus voltage from the rectified input voltage;
an electronic converter configured to generate at the two output terminals a regulated output voltage or a regulated output current from the bus voltage;
an auxiliary power supply configured to generate an auxiliary supply voltage; and
a power supply control circuit configured to:
generate a signal indicative of output power provided via the two output terminals;
determine whether the signal indicates that the output power is greater than a threshold value;
in response to determining that the signal indicates that the output power is greater than the threshold value, supply a PFC control circuit with the auxiliary supply voltage; and
in response to determining that the signal indicates that the output power is less than the threshold value:
generate a signal indicative of the bus voltage;
determine whether the signal indicates that the bus voltage is greater than an upper threshold, and in response to determining that the signal indicates that the bus voltage is greater than the upper threshold, inhibit supply of the PFC control circuit with the auxiliary supply voltage, whereby the PFC control circuit is switched off; and
determine whether the signal indicates that the bus voltage is less than a lower threshold, and in response to determining that the signal indicates that the bus voltage is less than the lower threshold, supply the PFC control circuit with the auxiliary supply voltage.

13. The power supply device according to claim 12, wherein the auxiliary power supply includes a capacitor and a charge circuit configured to charge the capacitor via the rectified input voltage.

14. The power supply device according to claim 13, wherein the electronic converter is a flyback converter including a transformer having an auxiliary winding, wherein the auxiliary winding is coupled via a first diode to the capacitor.

15. The power supply device according to claim 12, wherein the PFC control circuit is configured, when supplied via the supply voltage, to drive a second electronic switch in order to regulate a feedback signal to a reference value.

16. The power supply device according to claim 12, wherein generating the signal indicative of the output power provided via the two output terminals includes:
estimating a signal proportional to the output voltage and a signal proportional to the output current, and generating the signal indicative of the output power by multiplying the signal proportional to the output voltage with the signal proportional to the output current; or
estimating a signal proportional to the bus voltage and a signal proportional to the current provided to the electronic converter, and generating the signal indicative of the output power by multiplying the signal proportional to the output voltage with the signal proportional to the output current.

17. The power supply device according to claim 12, wherein:
the electronic converter is configured to generate the regulated output voltage, and the signal indicative of the output power is proportional to the output current provided via the two output terminals; or
the electronic converter is configured to generate the regulated output current, and the signal indicative of the output power is proportional to the output voltage at the two output terminals.

18. A method of operating a power supply, comprising:
generating a signal indicative of an output power provided via two output terminals;
determining whether the signal indicates that the output power is greater than a threshold value;
in response to determining that the signal indicates that the output power is greater than a threshold value, supplying a Power-Factor Correction (PFC) control circuit with an auxiliary supply voltage; and
in response to determining that the signal indicates that the output power is less than a threshold value:
generating a signal indicative of a bus voltage;
determining whether the signal indicates that the bus voltage is greater than an upper threshold, and in response to determining that the signal indicates that the bus voltage is greater than the upper threshold, inhibiting supply of the PFC control circuit with the auxiliary supply voltage, whereby the PFC control circuit is switched off; and
determining whether the signal indicates that the bus voltage is less than a lower threshold, and in response to determining that the signal indicates that the bus voltage is less than the lower threshold, supplying the PFC control circuit with the auxiliary supply voltage.

19. The method according to claim 18, wherein generating the signal indicative of the output power provided via the two output terminals includes:
estimating a signal proportional to an output voltage and a signal proportional to the output current, and generating the signal indicative of the output power by multiplying the signal proportional to the output voltage with the signal proportional to the output current; or
estimating a signal proportional to the bus voltage and a signal proportional to the current provided to an electronic converter, and generating the signal indicative of the output power by multiplying the signal proportional to the output voltage with the signal proportional to the output current.

20. The method according to claim 18, comprising:
estimating the output voltage by sampling a voltage at an auxiliary winding of a converter during a switch-off period of the converter.
